(19) United States
(12) Patent Application Publication
(10) Pub. No.: US 2021/0283464 A1
(43) Pub. Date: Sep. 16, 2021

(54) TARGET-BASED TRAINING SYSTEM

(71) Applicant: Terry Bullman, Knoxville, TN (US)

(72) Inventor: Terry Bullman, Knoxville, TN (US)

(21) Appl. No.: 17/197,777

(22) Filed: Mar. 10, 2021

Related U.S. Application Data
(60) Provisional application No. 62/987,575, filed on Mar. 10, 2020.

(51) Int. Cl. A63B 24/00; G06K 9/62

(52) U.S. Cl. CPC A63B 24/0075; G06K 9/6256; A63B 2022/0092; A63B 24/0003; A63B 24/0062

(57) ABSTRACT

A target-based training system that includes two or more participant stations that are arranged in a circuit and that each provide a target-based training activity. Each participant station includes one or more targets that are engaged through physical strikes. One or more sensors are associated with each of the one or more targets that capture engagement data related to a participant's physical strikes on the target. A computer is configured to receive engagement data and to generate a score based on the engagement data with the two or more participant stations.

### CROSS-REFERENCE TO RELATED APPLICATIONS

This application claims the benefit of U.S. Provisional Application No. 62/987,575 filed Mar. 10, 2020, and entitled TARGET-BASED TRAINING SYSTEM, which is incorporated herein by reference in its entirety.

### FIELD

This invention relates generally to fitness training equipment. More particularly, the invention relates to a system of single- or multi-target participant stations for use during the performance of a fitness activities by one or more participants, including circuit-type fitness activities.

### BACKGROUND

Fitness and training activities are often performed in a controlled training environment as a means to safely train particular skills or movements that may be utilized at a later time in the real world. For example, training disciplines such as krav maga, judo, boxing, etc. are often taught in a safe, instructive environment, but may also be later used in real life, such as in combat. Similar training activities are performed in firearms training, such as at a firing range, to perfect mechanics of drawing, aiming, firing, reloading, and holstering a weapon. Many participants engage in these and other similar activities solely for recreational purposes and, for those types of participants, low-stress training environments are sufficient.

However, many others participate in these activities as a means for training for high-stress environments that would require them to use those skills, such as competitions or for self-defense purposes. Carrying out a particular skill while under stress is significantly different from carrying out that skill while under low or no stress. For example, maintaining proper form and high accuracy during firearms training activities become increasingly more difficult as the level of stress increases. This is due, in large part, to the body's physiological response (e.g., fight-or-flight response) to stress, which includes the release of stress hormones (e.g., adrenaline, cortisol, etc.) that increase heart rate and blood flow. Among other things, this release of hormones can cause a person to shake, freeze up, etc., which can severely and adversely impact their performance. For this reason, to accurately prepare for the real-life application of the above-described skills, this second group of participants must train under their skills under high stress conditions.

Executing physical activities with force and over an extended period of time can burn significant calories and fat. Therefore, using maximum force will improve the effectiveness of the exercise routine from a health improvement standpoint. However, again, accuracy remains important for certain activities such as marksmanship and martial arts. Therefore, maintaining a balance between force and accuracy is important in these types of activities.

Lastly, participants of group fitness classes are often confined to a single machine throughout the entire course of the class. For example, in a rowing class or biking class, participants remain with the same indoor rowing or biking machine throughout the entire class. In many of these classes, participants are placed into competition with one another in order to encourage engaged involvement. For example, in a rowing class, participants might race to achieve a particular distance faster than the other participants. However, there may be perceived or actual inconsistencies from one machine to the next, which may actually impact the score or be perceived to impact the score. For example, one indoor bicycle might be thought to be the “better bike” that participants opt for over the others because it provides higher scores than other indoor bicycles. This can lead to a sense of unfairness amongst the competitors.

Accordingly, what is needed, is a training system that tests accuracy while the participant is under a stress condition while also providing a fair competitive environment for all participants.

### NOTES ON CONSTRUCTION

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both movable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

### SUMMARY

The above and other problems are addressed by a target-based training system that includes two or more participant stations that are arranged in a circuit and that each provide a target-based training activity that includes one or more targets that are engaged through physical strikes. The system further includes one or more sensors associated with each of the one or more targets that each capture engagement data related to a participant's physical strikes on the target. Lastly, a computer is configured to receive engagement data and to generate a score based on the engagement data with the two or more participant stations.

In certain embodiments, each of the one or more targets further include a movable strike surface that is held in an uncompressed position by a biasing member and that is configured to move from to a compressed position in response to physical strikes. The one or more sensors are preferably configured to collect displacement information of the movable plate and at least a portion of the engagement data is derived from the displacement information. In certain cases, the one or more sensors include at least three position sensors distributed across the movable plate that measure displacement of the movable strike surface in response to a displacement force applied to the movable strike surface at a strike location in at least three different locations. Preferably, the computer triangulates the strike location based on the displacement of the movable strike surface at the at least three different locations and the score is at least partially based on a distance separating the strike location and an intended target center.

In certain embodiments, the movable strike surface includes a movable plate and the biasing member includes one or more springs connected to the movable plate. The system preferably includes guides mounted to the plate that are configured to slide within openings formed in a plate housing in order to constrain the motion of the plate as the plate moves between the compressed position and uncompressed position.

In certain preferred embodiments, a separate score is generated for a participant's engagement with each of the two or more participant stations. In certain cases, a separate score is generated each time one of the one or more targets is physically struck during a participant's engagement with each of the two or more participant stations. In some cases, a single score is generated for each of the two or more participant stations. Additionally, the single score is based on all engagement data captured during a participant's engagement with each of the two or more participant stations.

In certain embodiments, a participant platform is associated with at least one of the two or more participant stations, which participant station is activated only while a participant is located at and correctly engages the participant platform. No score is generated from engagement with the participant station until the participant platform associated with the participant station is activated. In certain embodiments, the participant platform is remote from the participant station such that projectile strikes are required to engage the one or more targets associated with the participant station. In certain cases, the participant platform includes a pressure pad upon which a participant must stand in order to correctly engage and active the participant platform.

In certain embodiments, the sensors are configured to detect a strike location of a strike onto the corresponding one or more targets and the score generated is based, at least in part, on a distance separating the strike location and an intended target center. In certain cases, the targets of at least one of the participant stations have strike surfaces with different surface areas. In certain cases, one of the participant stations is a wall-mounted station. In certain cases, a display is in communication with the computer and is configured to receive and then display the score. In certain cases, a separate display is associated with each of the participant stations.

In certain embodiments, the computer is configured to determine a magnitude of force of the participant's physical strikes on the target based on the engagement data and the score is at least partially based on the magnitude of force.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 depicts a target-based training system according to an embodiment of the present invention;

FIG. 2 depicts a single target of a multi-target participant station of the system shown in FIG. 1;

FIGS. 3-5 are cross-section views of the target shown in FIG. 3, taken along line “A-A”, in an uncompressed state, partially off-center compressed state, and partially center-compressed state, respectively;

FIGS. 6 and 7 depict targets having strike locations; and

FIG. 8 is a block diagram illustrating a portion of an electrical system used by the participant stations shown in FIG. 1;

FIG. 9 depicts a system of multi-target participant stations communicating to a display device via a network according to an embodiment of the present invention;

FIG. 10 depicts a single target of a multi-target training system according to an alternative embodiment of the present invention; and

FIG. 11 is a cross-section view of the target shown in FIG. 10, taken along line “B-B”, in an illuminated state.

### DETAILED DESCRIPTION

This description of the preferred embodiments of the invention is intended to be read in connection with the accompanying drawings, which are to be considered part of the entire written description of this invention. The drawings are not necessarily to scale, and certain features of the invention may be shown exaggerated in scale or in somewhat schematic form in the interest of clarity and conciseness.

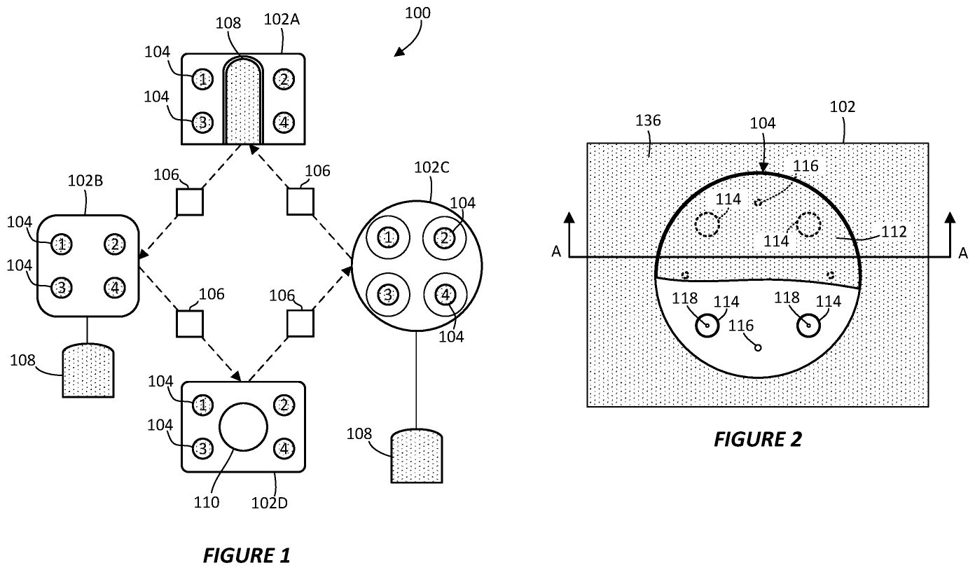

With initial reference to FIG. 1, there is provided a target-based training system 100 according to an embodiment of the present invention. The system 100 includes several multi-target participant stations 102 (numbered in FIG. 1 as 102A, 102B, 102C, 102D), each containing one or more targets 104, through which one or more participants cycle through during a multi-station exercise routine. At each station 102, participants perform an accuracy challenge or an endurance challenge. An accuracy challenge is a target-based training exercise that requires the participant to accurately and forcefully strike one or more of the targets 104 in a particular order, preferably using a maximum amount of force in most cases. During an endurance challenge, a participant repeatedly strikes a single target 104 as quickly as possible during a given timeframe, preferably using a maximum amount of force in most cases.

To improve the difficulty and to more closely simulate a “fight or flight” physiological response (e.g., increased heart rate, fatigue), participants may also be required to perform a physical challenge at a challenge station 106 during or between the performance of these accuracy and endurance challenges. The physical challenges performed at challenge stations 106 could include, for example, pushups, jumping jacks, rope climb, etc. After performing the physical challenge, participants proceed to the next participant station 102 and perform the accuracy or endurance challenge. Importantly, as depicted by the dashed arrows in FIG. 1, each participant cycles through each station 102 during the circuit in order to prevent the problem of one participant having the advantage (or perceived advantage) of using a preferred participant station.

Participant stations 102A, 102B, 102C each include a participant platform 108 on which participants stand while engaging targets 104. To encourage speed when moving between participant stations 102, according to certain embodiments of the invention, the participant stations are preferably activated only after a participant is located at and correctly engaging the participant platform 108 associated with that particular station. For example, in order to correctly engage certain participant platforms 108, a participant might be required to stand on a pressure pad located at the platform. Other types of actions might be required to correctly engage other types of participant platforms 108. Once activated, participants must quickly, accurately, and forcefully engage the targets 104 using a variety of movements or skills. Preferably, in at least certain modes of operation, engagement with a participant station 102 equipped with a participant platform is only counted or scored while the participant correctly engages with the participant platform.

Different participant stations 102 may test different accuracy skills. For example, participant station 102A is positioned on a ground surface and includes targets 104 that are positioned next to the participant platform 108. To engage the targets 104, participants may be instructed to use downward strikes onto the targets (e.g., with fists, feet, knees, elbows, rubber mace, rubber medicine ball, etc.). Participant station 102B is a close-range wall-mounted station having a participant platform 108 that is remote from the participant station but is still within reach of the participant. Participant station 102B is in electrical communication with participant platform 108 and, when in use, a participant would stand on participant platform and then use forward strikes (e.g., punches, kicks, etc.) to engage targets 104. Participant station 102C is a long range wall-mounted version having a participant platform 108 that is remote from the participant station that is not within reach of the participant. Participant station 102C is in electrical communication with participant platform 108 and, when in use, a participant would stand on participant platform 108 and then provide long distance (e.g., projectile) strikes onto the targets 104. This could include, for example, the participant of a laser or pellet gun to train combat-type skills. In other cases, athletic skills and accuracy could be tested and a participant might be instructed to hit targets 104 with baseballs or footballs. In addition to the numbered targets 104, participant station 102D also contains a larger, centrally-located and non-numbered endurance target 110. This target 110 is used to test a participant's endurance and, when in use, a participant would repeatedly strike the target as many times as possible. Since the aim of this particular exercise is speed and repeated strikes and is not accuracy, the surface area of the striking surface of target 110 is preferably larger than the surface area of the striking surface of targets 104. A participant may, for example, stand adjacent participant station 102D and then repeatedly strike target 110 with a rubber mace.

System 100 is intended to train speed and teamwork. So, in certain embodiments, a team works together to achieve the highest score in the least amount of time. In that case, participant stations 102 may not be activated until a participant is located at participant platform 108, which will encourage all members of a team to move through the stations quickly and in unison. In other cases, none of the stations 102 are activated until each participant on a team is located at the designated participant platform 108. System 100 is also intended to train situational awareness and to improve reaction times. For that reason, in preferred embodiments, strikes on targets 104 are only counted towards a participant's score when they are performed in the correct order onto an active target, which may be randomized by a computer communicating to the platforms (e.g., portions of targets 104 may illuminate to designate the active target) or designated by an instructor. This would test, for example, boxing punch combinations (e.g., 4-1-3-2).

With reference to FIGS. 2-5, the presently-disclosed system is intended to promote forceful and accurate strikes on targets 104. In preferred embodiments, the system is configured to detect the magnitude and location of force applied to each of targets 104 and to provide higher scores for strikes that are more accurate than those that are less accurate and for strikes with a higher force than those with a lesser force. In the illustrated embodiment, each target 104 includes a movable strike surface. In the illustrated case, the strike surface is illustrated as a movable plate 112 that is configured to move between an uncompressed position and a compressed position. Preferably, plate 112 is biased to the uncompressed position, such as by springs 114, which are preferably evenly spaced away from and uniformly distributed around a center of the plate. The motion of the plate 112 between the uncompressed and compressed positions is preferably constrained by guides 116 that slide within wells 138 formed in an upper housing 136. The system is configured to detect the amount of force applied to the plate 112. This could be calculated, for example, based on the mass and acceleration of the plate or by the spring force and amount of deflection of the plate, or both. In preferred embodiments, one or more sensors 118 (e.g., linear potentiometer, pressure sensor, impact sensor, displacement sensor, etc.) are provided to detect displacement of the plate 112 as well as the number and frequency of strikes onto the plate, and the force and location of strikes. By providing three or more such position sensors 118, the location of the center of the force applied to the plate 112 can be determined, such as through triangulation, by a computer. This will allow accuracy of the strike to be determined in addition to the amount of force to be determined. This information could then be used to score a participant's performance based on a combination of the force applied to the plate 112 and the accuracy of the strike. Of course, other position and displacement sensors known in the art could be used in place of those discussed above. In the illustrated embodiment, a lower housing 140 is mounted below the upper housing 136 and provides room for storing electronics associated with the target 104, including sensors 118 and a computer 142 that is used in performing at least some of the calculations needed to calculate the scores from a participant's engagement with the target 104.

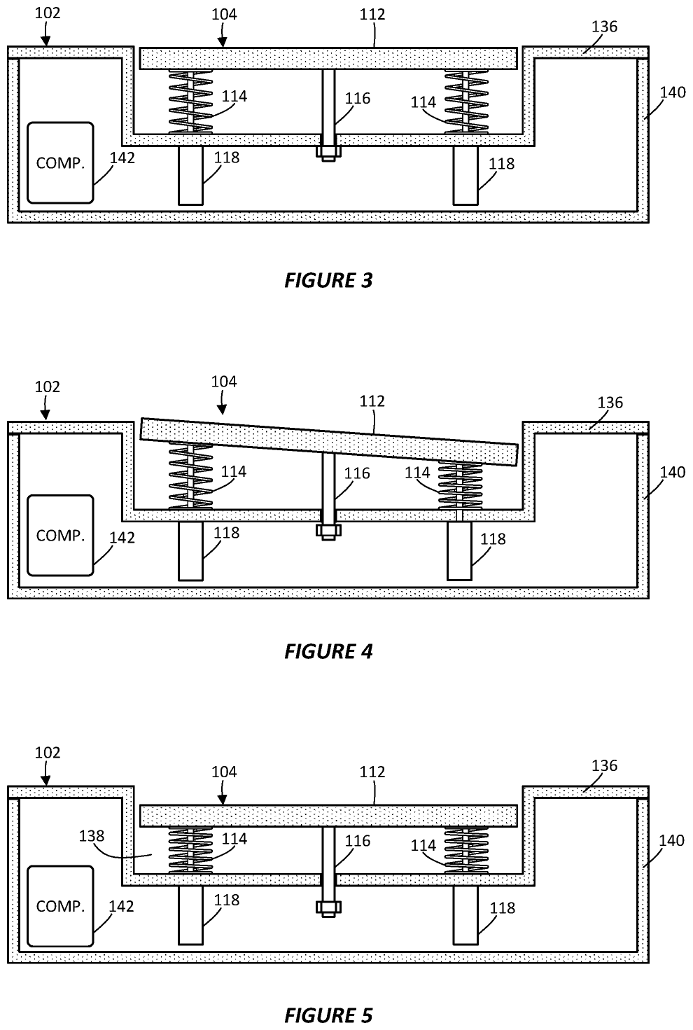

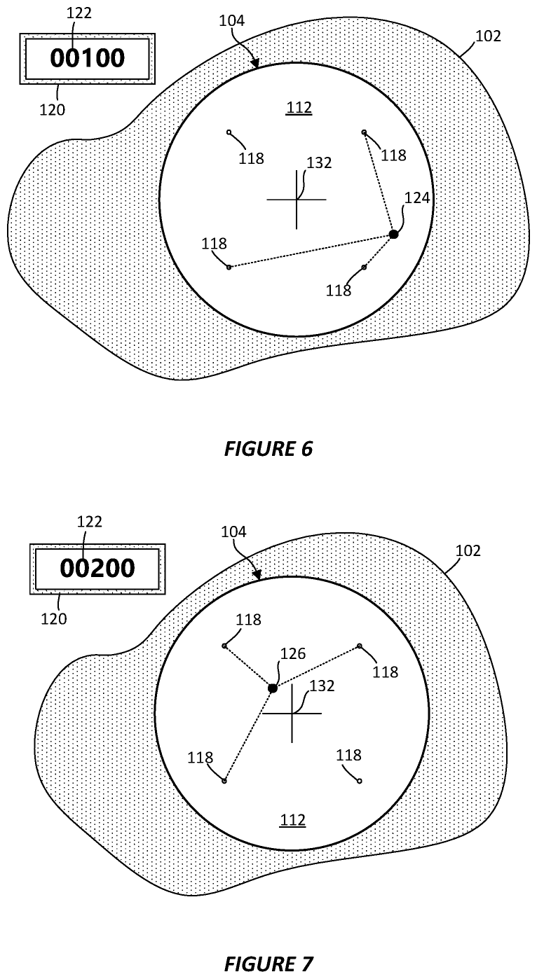

With reference now to FIG. 6, an off-center strike location 124 is shown. This strike location 124 is spaced away from the intended target center 132 that should have been hit. It is noted that the “target center” is the location on the target 104 where a strike should be centered. The “target center” may be located at the center of the target 104 or at some other location on the target. In certain embodiments, the target center for each target 104 may change. For example, the target center may be located at the center of a target 104 for a first strike and then located away from the center of the target for a subsequent strike. Preferably, a participant's score is at least partially determined by the accuracy of their strike on the target 104 (i.e., the distance between the strike location and the intended target center). In this first case, the off-center strike location 124 would result in plate 112 deflecting from the position shown in FIG. 3 to the position shown in FIG. 4, where one of the springs 114 (i.e., the right-most spring) is deflected more than other springs, which indicates an off-center strike. For this particular strike, the participant receives 100 points. Preferably, an individual display 120 is located nearby and is in communication with each participant station 102. The display 120 preferably immediately displays the participant's score 122 to the participant. This immediate feedback would motivate the participant to either continue performing the same way (if they scored well) or to modify their performance (if they scored poorly).

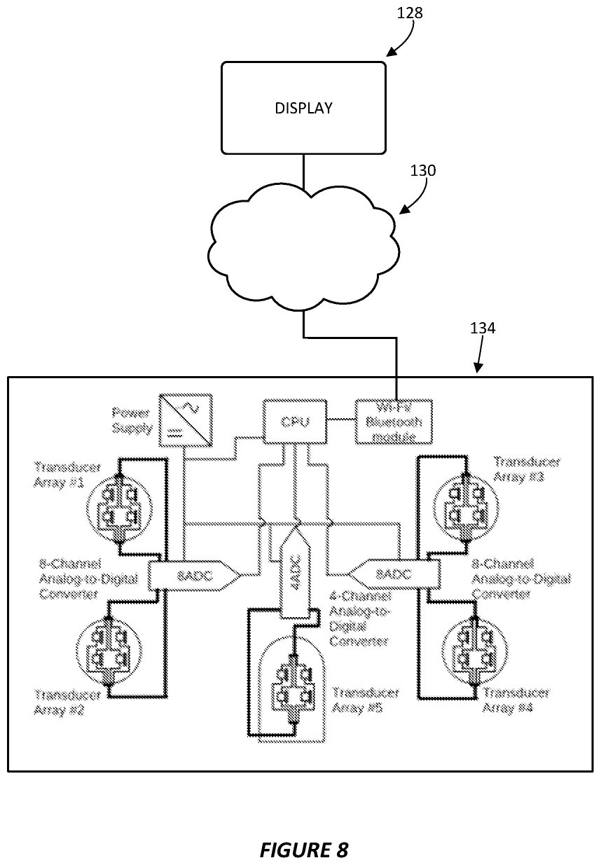

A second example is provided in FIG. 7, where, after striking poorly at strike location 124, the participant modifies their performance to achieve improved strike location 126, which is more centered and results in 200 points being awarded. This improved second strike would result in plate 112 deflecting springs 114 evenly, as shown in FIG. 5. Additionally, the improved score is immediately displayed to the participant.

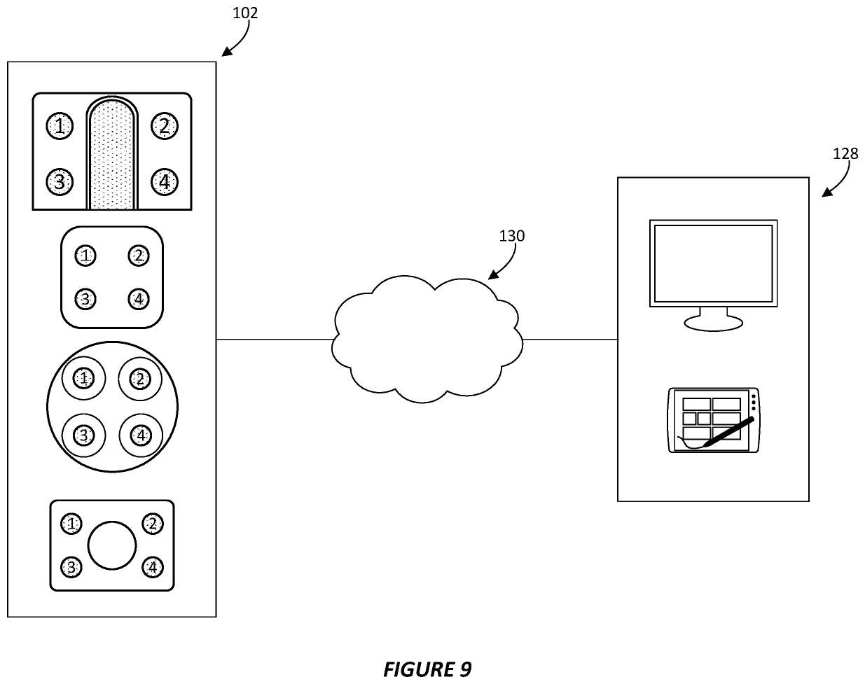

An electrical system may be used to control one or more of the participant stations 102, including calculating the strike characteristics (e.g., accuracy, speed and force) and provide a resulting score. For example, the electrical system 134 shown in FIG. 8 controls the operation of the participant stations 102 shown in FIG. 2. In preferred embodiments, a communications module (e.g., Wi-Fi, Bluetooth) is provided to communicate information from each of the participant stations 102 to a central display. This allows each of the participants to see their scores as well as the scores of others participants. As shown in FIG. 9, information is communicated from participant stations 102 to an external display 128 (e.g., tablet, electronic scoreboard, etc.), and takes place over a network 130, which may be wired or wireless.

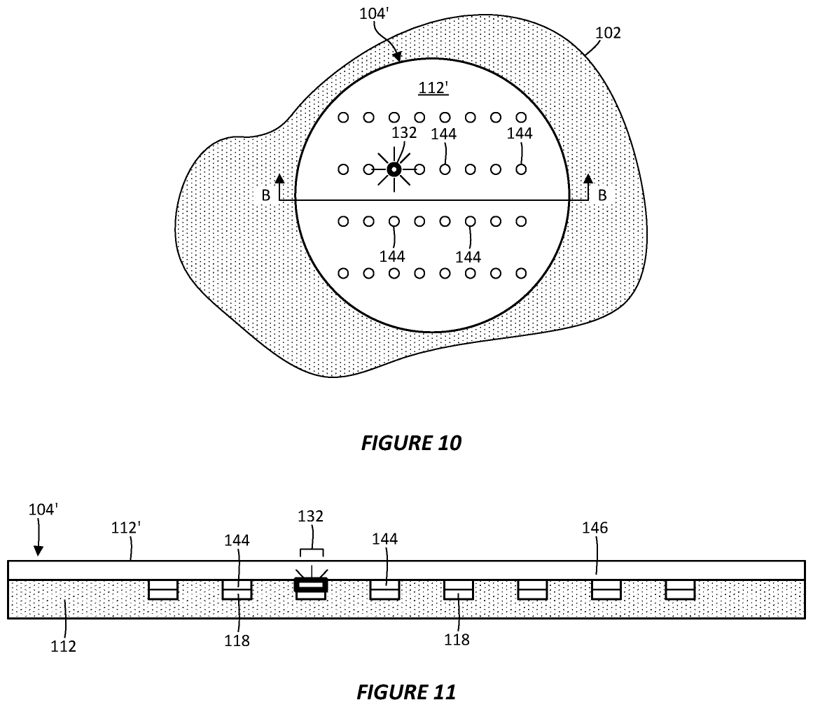

With reference to FIGS. 10 and 11, there is provided an alternative target 104′ that includes a strike surface 112′ that is illuminated by a plurality of lights 144 distributed across the strike surface that are visible to participants when illuminated. Lights 144 are preferably illuminated to show the target center 132, where a strike should be centered for a higher score. Lights 144 could be illuminated in a planned or random order, and the position of the illuminated light corresponds with the target center. In certain embodiments, target 104′ includes a padded top layer 146 is placed on top of an underlying plate 112. Preferably, top layer 146 allows the participant to see illumination from lights 144, which are preferably placed under the top layer, through the top layer. For example, in certain embodiments, top layer is formed from plastisol or another similar material. Additionally, sensors 118 are preferably located at or in close proximity to each of the lights 144.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A target-based training system comprising:
two or more participant stations that are arranged in a circuit and that each provide a target-based training activity that includes one or more targets that are engaged through physical strikes;
one or more sensors associated with each of the one or more targets that each capture engagement data related to a participant's physical strikes on the target;
a computer configured to receive engagement data and to generate a score based on the engagement data with the two or more participant stations.

2. The system of claim 1 wherein each of the one or more targets further comprise a movable strike surface that is held in an uncompressed position by a biasing member and that is configured to move from to a compressed position in response to physical strikes, wherein the one or more sensors are configured to collect displacement information of the movable plate and at least a portion of the engagement data is derived from the displacement information.

3. The system of claim 2 wherein the one or more sensors include at least three position sensors distributed across the movable plate, the at least three position sensors are configured to measure displacement of the movable strike surface in response to a displacement force applied to the movable strike surface at a strike location in at least three different locations, wherein the computer triangulates the strike location based on the displacement of the movable strike surface at the at least three different locations, and wherein the score is at least partially based on a distance separating the strike location and an intended target center.

4. The system of claim 2 wherein the movable strike surface comprises a movable plate and the biasing member comprises one or more springs connected to the movable plate, the system further comprising guides mounted to the plate that are configured to slide within openings formed in a plate housing in order to constrain the motion of the plate as the plate moves between the compressed position and uncompressed position.

5. The system of claim 1 wherein a separate score is generated for a participant's engagement with each of the two or more participant stations.

6. The system of claim 1 wherein a separate score is generated each time one of the one or more targets is physically struck during a participant's engagement with each of the two or more participant stations.

7. The system of claim 1 wherein a single score is generated for each of the two or more participant stations, wherein the single score is based on all engagement data captured during a participant's engagement with each of the two or more participant stations.

8. The system of claim 1 further comprising a participant platform associated with at least one of the two or more participant stations that is activated only while a participant is located at and correctly engages the participant platform, wherein no score is generated from engagement with the at least one participant station until the participant platform associated with the at least one participant station is activated.

9. The system of claim 8 wherein the participant platform is remote from the at least one participant station such that projectile strikes are required to engage the one or more targets associated with the at least one participant station.

10. The system of claim 8 wherein the participant platform comprises a pressure pad upon which a participant must stand in order to correctly engage and active the participant platform.

11. The system of claim 1 wherein the one or more sensors are configured to detect a strike location of a strike onto the corresponding one or more targets and wherein the score generated is based, at least in part, on a distance separating the strike location and an intended target center.

12. The system of claim 1 wherein targets of one of the two or more participant stations have strike surfaces with different surface areas.

13. The system of claim 1 wherein one of the two or more participant stations is a wall-mounted station.

14. The system of claim 1 further comprising a display that is in communication with the computer and is configured to receive and then display the score.

15. The system of claim 14 further comprising a separate display that is associated with each of the two or more participant stations.

16. The system of claim 1 wherein the computer is configured to determine a magnitude of force of the participant's physical strikes on the target based on the engagement data and wherein the score is at least partially based on the magnitude of force.

17. A method of training:
providing a target-based training system that includes
a first participant station and a second participant station that are arranged in a circuit and that each provide a target-based training activity that includes one or more targets that are engaged through physical strikes;
one or more sensors associated with each of the one or more targets that each capture engagement data related to a participant's physical strikes on the target;
a computer in communication with the one or more sensors;
engaging the one or more targets of the first participant station;
moving to the second participant station and engaging the one or more targets of the second participant station;
with the computer, receiving engagement data from the one or more sensors and generating a score based on the engagement data with the two or more participant stations.
